(19) United States
(12) Patent Application Publication
(10) Pub. No.: US 2009/0220122 A1
(43) Pub. Date: Sep. 3, 2009

(54) TRACKING SYSTEM FOR ORTHOGNATHIC SURGERY

(75) Inventors: Robin Richards, West Sussex (GB); Andrew McCance, West Sussex (GB)

Correspondence Address: STEPTOE & JOHNSON LLP, 2121 AVENUE OF THE STARS, SUITE 2800, LOS ANGELES, CA, 90067, US

(73) Assignee: ORTHO-PRO-TEKNICA LIMITED, East Grinstead, West Sussex (UK)

(21) Appl. No.: 12/093,311

(22) PCT Filed: Nov. 10, 2006
(86) PCT No.: PCT/GB06/04207

§ 371 Date: Aug. 19, 2008

(30) Foreign Application Priority Data
Nov. 11, 2005 (GB) 0523085.9

(51) Int. Cl. G06K 9/00

(52) U.S. Cl. 382/103; 382/128

(57) ABSTRACT

Systems and methods are provided for measuring relative movement between two portions of the facial skeleton. A target (4) is fixed in position relative t a one of the portions of the facial skeleton, the target comprising three or more light sources having a known geometric relationship with one another. An image capture device (2) is fixed in position relative to the other of the portions of the facial skeleton for capturing images of the three or more light sources of the target. The captured images can be used to determine relative changes in portion and orientation of the two portions of the facial skeleton.

### FIELD OF THE INVENTION

This invention relates to a tracking system for orthognathic surgery and a method of operation of the system.

### BACKGROUND

Orthognathic surgery involves the surgical manipulation, through osteotemy, of the facial skeleton, in particular the maxilla (upper jaw) and the mandible (lower jaw), to correct a variety of abnormalities in the facial skeleton. The aim of such surgery is to restore the correct anatomic relationship between the maxilla and the mandible and the rest of the facial skeleton for aesthetic and functional reasons.

The surgery is planned in advance, typically using physical or computer-based models of the patient's facial skeleton, to map out the osteotomies and subsequent movements of the maxilla and/or mandible that are required to obtain the desired correction of the facial skeletal structure. In practice, however, it is difficult to ensure the accuracy of the movements that are made during the surgery itself and studies have shown that in many cases the results achieved, whilst being an improvement over the pre-operative condition, differ significantly from what was intended based on the model. See for example Le Fort I maxillary osteotomy: is it possible to accurately produce planned preoperative movements? McCance A. M. et al, British Journal of Oral and Maxillofacial Surgery 30,369-376, 1992

In their paper Model Surgery With a Passive Robot Arm for Orthognathic Surgery Planning, Journal of Oral and Maxillofacial Surgery, 2003; 61 (11): 1310-1317, Theodossy and Bamber describe the use of a robot arm to accurately determine the change in position of the maxilla during model surgery and show that this is more accurate than conventional manual procedures. They suggest at the end of their paper that the robot arm might be used on surgical patients for pre- and post-operative measurements and go on to more tentatively suggest that it might have application in the operating room to aid in the localisation of points during orthognathic procedures. In order to provide accurate measurements during orthognathic procedures using such as system it would be necessary to fix the position of the patient's skull with respect to the robot arm, which would be difficult to achieve to the accuracy required.

### SUMMARY OF INVENTION

The present invention proposes a system and method for determining a change in position of a portion of the jaw (e.g. the maxilla or mandible) in relation to a predetermined reference point elsewhere on the facial skeleton based on captured images of an arrangement of three or more light sources that are fixed in position relative to one another and that have a known positional relationship to either the relevant portion of the jaw or the reference point, the images being captured by an image capture device that has a known positional relationship to the other of the relevant portion of the jaw and the reference point.

In a first aspect, the invention provides a system for measuring relative movement between two portions of the facial skeleton, the system comprising:
a target fixed in position relative to a one of said portions of the facial skeleton, the target comprising three or more light sources having a known geometric relationship with one another; and
an image capture device fixed in position relative to the other of said portions of the facial skeleton for capturing images of the three or more light sources of the target.

In use, the image capture device is positioned relative to the target so that it can capture images of the light sources as the two portions of the facial skeleton are moved relative to one another. The changes in the pattern of spots created by the light sources in successively captured images can be used to determine the relative movement that has occurred. Advantageously, this tracking of the relative movement can be achieved using only a single image capture device.

For use in orthognathic surgery, the target will typically be fixed in position relative to the patient's maxilla or their mandible and the image capture device will be fixed in position relative to the remainder of the facial skeleton. In this way, the major part of the facial skeleton or skull more generally serves as a frame of reference for movements of the maxilla or mandible. Conveniently, the image capture device can be fixed in position adjacent the frontal bone or nasal bone so that it can look down on the target from above.

The light sources on the target are preferably held at a fixed distance from one another that is sufficiently great that they can be readily distinguished from one another in images captured by the image capture device, whilst being sufficiently close to one another that they all remain in the field of view of the image capture device throughout the expected movement of the facial skeleton.

The use of three light sources, which define a plane, makes it possible to measure movement in any dimension. More preferably, however, the target includes four distinct light sources, or more than four, such that there is some redundancy in the pattern of light sources detected by the image capture device. This allows, for instance, the one or more redundant light sources in an image to be used to provide a measure of the reliability of the detected relative movement of the jaw portions.

In some embodiments of the invention the light sources on the target may all lie in a single plane, which at the beginning of a procedure will typically be aligned to be generally orthogonal to the focal axis of the image capture device.

More preferably, however, in a target having four or more light sources, the light sources are arranged in a three-dimensional configuration so that they are not all in the same plane. This gives the captured image of the light source some depth, meaning that for some rotational movements of the target relative to the image capture device (i.e. those movements have a rotational element about an axis orthogonal to the focal axis of the image capture device) the perceived change in the pattern of spots in the image will be greater than for light sources in a single plane, giving the system greater sensitivity to these rotational movements.

In one preferred embodiment, the target comprises four light sources arranged in a tetrahedral configuration. The light sources may be arranged, for example, with two light sources in a first plane and another two light sources in a second plane, parallel to the first. In use, the target is preferably oriented such that these two planes are offset from one another along the focal axis of the image capture device. Conveniently, the four light sources may be configured as a cross when viewed in a direction orthogonal to the planes containing the light sources, with the light sources in one plane forming one arm of the cross and those in the other plane forming the other arm for instance. This allows a simple construction for the structure of the target in which the light sources are housed.

The light sources themselves are preferably of a uniform shape (e.g. circular) and intensity. Any of a number of suitable light sources may be used. One example of an appropriate light source is a light emitting diode (LED). The discrete light source visible on the detector may share a common source of generated light.

Preferably the target comprises a body in which the light sources are mounted, a surface of the body on which the sources are visible preferably having a colour that contrasts with the colour of the light sources to help the clarity of the image of the spot pattern. For example, the surface may be a dark colour tone, e.g. black, and preferably has a matt finish. The light sources are preferably mounted in the surface of the target body in such a way that they have a generally uniform intensity irrespective of the viewing angle within several degrees, e.g. 1, 2, 3, 4 or 5 degrees of an axis through the light source, parallel to the focal axis of the image capture device. With an arrangement of four light sources in two planes it has been possible to reliably track rotations of +/−25 degrees or more.

The colour of the LEDs, or other light sources, may be chosen to also maximise the clarity of the captured image. Red LEDs have been shown to work well.

The image capture device may be a digital camera, for example a camera comprising a charge coupled device (CCD) as the image capture element. Cameras sold as ‘webcams’ can be used. Images captured by the image capture device are preferably transmitted to a processing means. They may be transmitted by a wired or a wireless connection.

The image capture device preferably has a short effective shutter speed; that is a short exposure or integration time for the capture of any one image/frame. This gives a sharper image. A shutter speed of no more than 2 msec is preferred, preferably 1 msec or less.

The resolution of the image capture device should also be chosen to ensure that a clear image of the pattern of spots created by the light sources can be obtained. For example, in the case of a CCD device, the resolution of the CCD is preferably such that the image of any one of the spots spans more than one pixel of the CCD as this will allow the location of the spot in the captured image to be more accurately determined.

Another variable in relation to image capture is the frame rate; that is the frequency at which subsequent images are captured. Higher frame rates will improve the accuracy of tracking a path of movement of the target but, with most webcams, if the frame rate is too high the image quality may suffer. Frame rates from 2 to 10 frames per second are preferred, with a frame rate of about 5 frames per second represents a good compromise between accuracy of tracking movement and quality of image.

In static conditions, for example at the beginning of a surgical procedure before any movement has started or at the end of a movement, data from multiple captured images can be averaged to provide a greater accuracy.

The accuracy of the system in determining relative movements of portions of the facial skeleton is dependent to a large extent on the secure mounting of the target and image capture device to hold them in a fixed position relative to the respective portions of the skeleton the system is detecting relative movement between.

It is proposed, in preferred embodiments of the invention, to mount the target in fixed position with respect to the maxilla or the mandible by mounting the target on the patient's upper or lower teeth respectively. The system therefore preferably includes a support structure for the target that comprises a fixture adapted to be secured to the patient's teeth and a target mounting portion that, in use, protrudes forwardly from the patient's mouth and on which the target can be mounted, or alternatively that the target can be formed integrally with. The fixture is preferably an occlusal wafer, which in a known manner can be moulded to fit over the patient's teeth to be firmly secured to them. As the wafer is formed for the specific patient it locates accurately and reproducibly giving a very accurate, known position of the target mounted on it relative to the maxilla or mandible that is being manipulated.

In preferred embodiments, the image capture device (e.g. CCD camera) is mounted adjacent the frontal bone or nasal bone of the patient's facial skeleton, that is adjacent their forehead and/or the bridge of their nose. A camera mount is preferably provided to hold the image capture device in a fixed position relative to the portion of the facial skeleton it is adjacent. The camera mount may be invasive, such as a screw fixing to the patient's frontal bone or another portion of their facial skeleton, but it is preferable to use a non-invasive camera mount.

In preferred embodiments the camera mount comprises a face-engaging portion that is located on the patient's forehead and/or the bridge of their nose. For example, the face-engaging portion of the camera mount can have the form of a pair of eyeglasses.

To ensure an accurate, repeatable location for the image capture device when mounted on the patient using a non-invasive camera mount, the face-engaging portion of the mount is preferably formed to closely match the contours of the patient's face that it overlies. For instance, a face engaging surface of the camera mount can be moulded to the shape of the patient's face. The camera mount is also preferably secured in place with a strap around the patient's head that in use is under tension to pull the face engaging surface of the camera mount against the patient's face.

The various components of the system are preferably adapted to allow them to be sterilised, for example by autoclave or chemical sterilisation techniques. This facilitates the re-use of the system for multiple patients. Alternatively, one or more parts of the system that come into contact with the patient may be disposable, in the sense that they are used for one patient and then discarded.

The system preferably also includes processing means that calculates a change in position of the facial skeleton portions with respect to one another based on a series of two or more images of the target captured by the image capture means.

Preferably, the processing means determines that position and orientation of the target relative to the image capture device, as seen in any particular captured image, by comparing the pattern of spots in the image with a virtual model of the target that models the geometry of the light sources.

The virtual model is manipulated to find a best fit with the pattern of spots observed in the captured image, the position and orientation of the model once a best fit is found being taken as the position and orientation of the target at the time the image was captured. The change in position and orientation of the model when it is matched against successive captured images then provides a measure of the movement of the target relative to the image capture device and hence a measure of the relative movement between the two portions of the facial skeleton that these components are mounted on.

The processing means may be implemented in software running on a computer or computer network.

In another aspect, the invention provides a method of measuring relative movement between two portions of a facial skeleton, the method comprising:
mounting a target in a fixed position relative to one of said facial skeleton portions, the target comprising two or more light sources having a known geometric relationship with one another;
mounting an image capture device in a fixed position relative to the other of said facial skeleton portions, the image capture device being oriented such that the light sources of the target re within its field of vision;
capturing with the image capture device a series of two or more images of the pattern of spots formed by the light sources on the target; and
calculating a relative movement of one portion of the facial skeleton with respect to the other based on a change in the pattern of spots between one captured image and one or more subsequently captured images in the series of captured images.

When the image capture device is first mounted on the patient, it is preferably positioned so that the light sources are within the field of view of the image capture device and will stay within the field of view throughout the anticipated movement of the target with respect to the image capture device.

In a further aspect the invention provides computer software that when run on a computer or computer network is operable to calculate a relative movement of one portion of the facial skeleton with respect to the other based on a change in the pattern of spots between one captured image and one or more subsequently captured images in the series of captured images.

The tracking system has wider applicability than the facial skeleton related application that it is described in the context of above.

Accordingly, in another aspect, the invention provides a system for measuring relative movement between two objects, the system comprising:
a target fixed in position relative to a one of said objects, the target comprising three or more light sources having a known geometric relationship with one another; and
an image capture device fixed in position relative to the other of said objects for capturing images of the three or more light sources of the target.

The invention also provides a method of measuring relative movement between two objects, the method comprising:
mounting a target in a fixed position relative to one of said objects, the target comprising three or more light sources having a known geometric relationship with one another;
mounting an image capture device in a fixed position relative to the other of said objects, the image capture device being oriented such that the light sources of the target are within its field of vision;
capturing with the image capture device a series of two or more images of the pattern of spots formed by the light sources on the target; and
calculating a relative movement of one of the objects with respect to the other based on a change in the pattern of spots between one captured image and one or more subsequently captured images in the series of captured images.

### BRIEF DESCRIPTION OF DRAWINGS

Embodiments of the invention will now be described, by way of example only, with reference to the accompanying drawings, in which:

FIG. 1 is a schematic illustration of the tracking system of the present invention mounted on a patient;

FIG. 2a shows, in more detail, a plan view of the target of the system of FIG. 1 and its support;

FIG. 2b is a view from the left hand end of the target as seen in FIG. 2a

FIG. 3 shows, in more detail, the camera mount of the system of FIG. 1; and

FIG. 4 is a flow diagram illustrating the steps in a process for operating the system of FIG. 1.

### DESCRIPTION OF EMBODIMENT

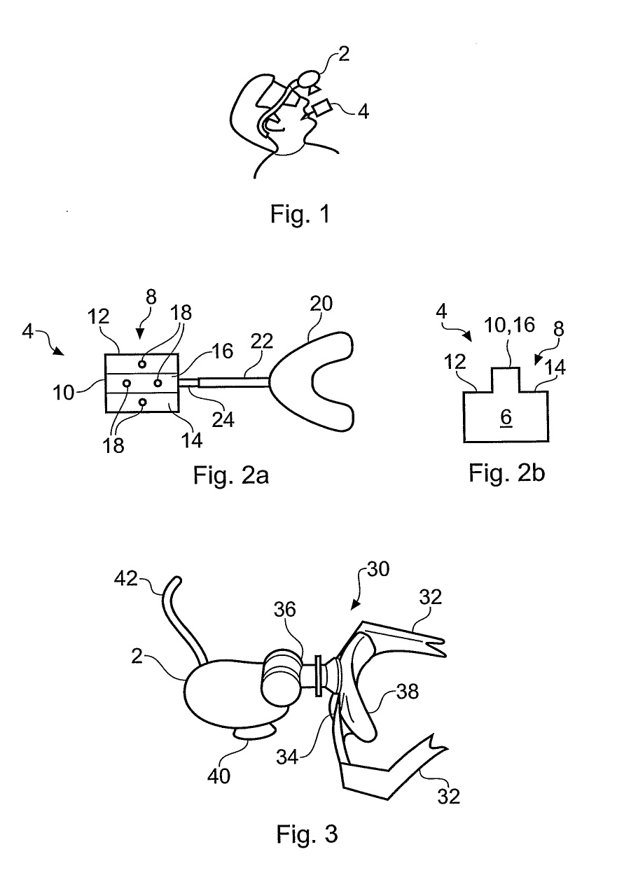

FIG. 1 shows a tracking system in which a camera 2 fixed in position adjacent a patient's forehead is used to track the movement of a target 4 that is fixed in position relative to the patient's maxilla in order to track movement of the maxilla relative to the remainder of the facial skeleton during orthognathic surgery. The camera 2 captures a series of images of the target 4, which are compared with a virtual model of the target to calculate any change in position and/or orientation of the target relative to the camera and hence of the maxilla.

As seen best in FIGS. 2a and 2b, the target 4 has a main body 6 that is generally cuboid in form save for an upper, stepped surface 8. It may, for example, be a machined block of aluminium. The upper surface has a raised ridge 10 along its centre line such that the surface has three plateaus 12, 14, 16, two of which 12, 14 are in the same plane as one another, to either side of a central plateau 16 formed by the ridge 10 that is parallel with but raised above the other two plateaus 12, 14.

Four light sources 18, in this example LEDs, are mounted on the stepped surface 8 of the target 4, which in use faces toward the camera 2. Two of the LEDs are mounted in the raised plateau 16, spaced apart along the ridge from one another. The other two LEDs are mounted one on each of the two lower plateaus 12, 14, opposite one another to either side of the ridge 10. In this example they are located at the mid-point along the ridge. Each LED has a diameter of 0.5 mm.

The upper surface 8 of the target 4 is formed of a thin sheet material, for example a thin metal plate having apertures behind which the LEDs 18 are set. Each LED 18 is positioned close to the outer surface of the plate behind a thin diffuser layer to provide wide beam of uniform intensity of light so that rotation of the target has minimal effect on the intensity of the observed spots of light.

At least the upper surface 8 of the target body 6 has a matt black finish to maximize contrast between the LEDs 18, which in this example are ultrabright red LEDs, and the surface 8 in which they are mounted. This improves the contrast in the image and makes it easier to process the image to determine the location of the spots within the image, even within ambient lighting conditions.

In this example, the LEDs 18 are powered by a battery housed within the target body 6. Using an internal power supply in this way avoids the need for a wired connection to an external power source.

The target 4 is fixed in position relative to the maxilla using a support structure that includes an occlusal wafer 20 of conventional form except that protruding from the front of the wafer 20 there is a target mounting arm 22. In this example, the arm 22 is of hollow, square section and the target 4 has a corresponding square section arm 24 protruding from one side of its body 6. The arm 24 on the target 4 fits into the hollow section of the target mounting arm 22 of the support and can be pushed in as far as a stop to positively and accurately locate the target 4 with respect to the occlusal wafer 20. The wafer 20 is moulded, in a known manner, to fit snugly over the upper teeth of the patient to locate the wafer 20 and hence the target 4 in the desired fixed position relative to the patient's maxilla.

The cooperating square section arms 24, 22 of the target and its support are only one example of possible cooperating connecting elements. Many variations of this are possible. What is important is that the connection accurately locates the components relative to one another in a reproducible manner. Alternatively, the target and its support may be permanently fixed to one another.

The camera 2 must also be secured in a fixed position relative to the patient's facial skeleton to provide a fixed frame of reference within which the relative displacement and orientation of the maxilla can be measured. This is achieved using a camera mount 30 that takes the form of a pair of glasses, as best seen in FIG. 3, having a pair of arms 32 connected by a bridge piece 34. In this example, the camera mount 30 is in fact an adapted pair of laboratory safety glasses

The camera 2 itself is mounted at the centre of the bridge piece 34 (adjacent the nasion point) via an articulated coupling 36, for example a ball and socket joint. This allows for initial setup of the camera 2 to ensure that the target 4 is within the camera's field of vision and will remain so throughout the planned movement of the maxilla. In the illustrated set up, movements of about 20-30 mm and rotations of 20-30 degrees can be accommodated (normally in a maxillary osteotomy the maxilla is moved by no more than about 10 mm and rotated by no more than 2-3 degrees, well within the capabilities of the proposed system). Once the initial setup is complete, however, the articulated coupling 36 is locked in place as it is important that the position of the camera 2 remains fixed.

On the rear side of the bridge piece 34 of the camera mount 30, i.e. the side facing the patient's forehead, there is a moulded face contacting element 38 that is shaped to lie snugly against the patient's face, especially their forehead and the bridge of their nose, to positively locate the camera mount 30 in a fixed position relative to the nasion point. The rear ends (not shown) of the arms 32 of the camera mount 30 are connected by an adjustable strap (not shown) that can be tightened around the rear of the patient's head.

The camera 2 itself is a CCD device. In this example, the device used was a Philips Toucam 740 CCD webcam (640*480 pixel). Modifications to the camera 2 were made to limit the aperture to 1 mm to increase the depth of field and decrease the light input. The camera 2 has a screw thread mounted lens 40 to allow focus adjustment. A spacer (washer) was fitted between the lens and the camera body so that the lens could be firmly secured at a suitable position to get good focus at the normal target range.

The camera 2 has a USB interface 42 for connection to a PC for transmitting digital images to the PC and for power supply to the camera. The PC runs tracking software to receive a series of digital images captured by the camera. The tracking software processes the images to determine the movement of the target 2, and hence the maxilla, within the frame of reference provided by the fixed camera 2, as described in more detail below.

The default measurements are in the co-ordinate frame of the camera CCD (x & y in the CCD plane and z normal to it). The software allows for the setting of a reference position so that calculations can be made in the frame of reference of the target position at the start of the process. Since the target is mounted in alignment with the occlusal plane of the teeth, this allows movements to be related to the initial and intended position of the teeth.

Noise in the system may cause small variations in successive images even when the target is stationary. Provision is made, therefore, to average a number of consecutive images to improve accuracy when the target is known to be stationary. Measurements are displayed in the camera frame of reference. In practice, the measurement of interest is a displacement from an initial position in the frame of reference of the target. To this end, the software allows the initial (averaged) position of the target to be used to define a reference position and orientation for subsequent measurements.

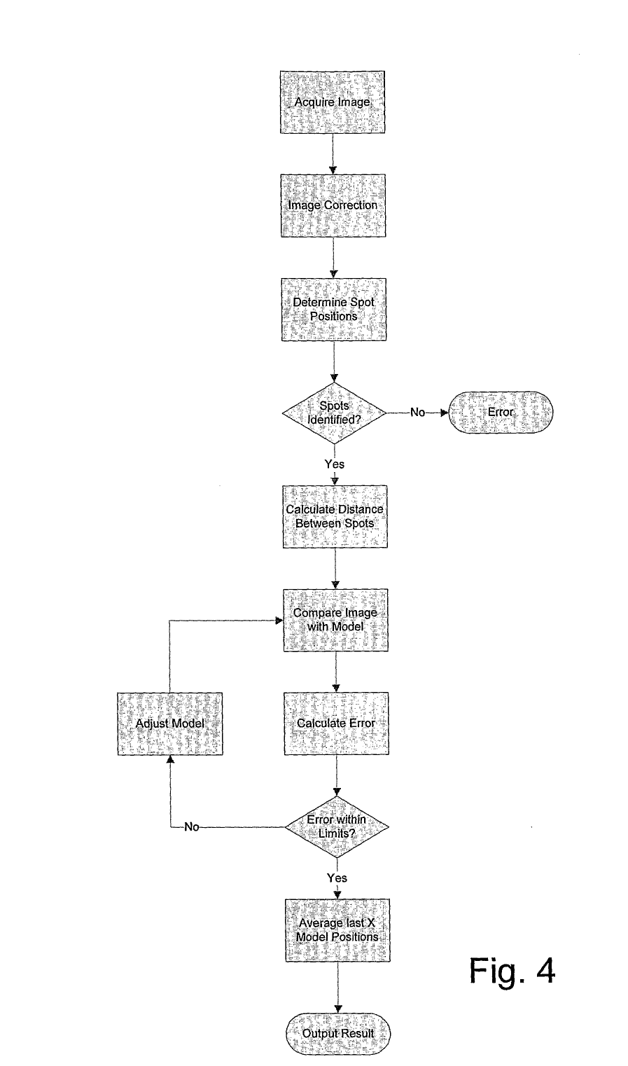

FIG. 4 shows the steps taken by the tracking software to calculate movements of the target 4.

To start an image is acquired from the camera 2 and corrections are applied to the image to account for known errors in the optical system (for example lens aberrations and axis offset).

The positions of the spots within the image (i.e. their location on the CCD array) are determined. Advantageously, the software is designed to look specifically for red coloured spots, so will ignore other spots of light that incidentally appear in the image. The locations of the spots are recorded as X-Y positions on the CCD array. If, for any reason, a spurious spot is detected or a spot is missing; the resulting pattern of spots is almost certain to be inconsistent with the mathematical model of the target and will be reported as a tracking error by the software.

The distance between the spots is calculated and used as a measure of how far from the camera the target is. As the target moves closer to the camera the distance between the spots in the image will increase and vice versa.

The software then compares the locations of the spots with locations of corresponding model spots based on a virtual model of the target, especially the geometry of the light sources, with a known position and orientation relative to the camera. The starting position and orientation may, for example, be the previously calculated position of the actual target.

The error, that is the difference in positions, between the model spots and the spots in the captured image are then determined and the position and orientation of the virtual model adjusted to reduce this error. This process continues in an iterative manner until the error does not reduce appreciably for one iteration to the next and/or the error is below a predetermined threshold.

The final position and orientation of the virtual model, or more preferably an average of the last series of a predetermined number of model positions and orientations in which the remaining error has remained substantially constant, is then output as the measured position and orientation of the target in the captured image.

By comparing the positions and orientations of the target calculated from successively captured images, the movement of the target, and hence the maxilla, can be tracked.

### EXPERIMENTS

Experiments have been undertaken to validate the system components.

### A. Validating the Safety Glasses.

Strong plastic safety glasses (Bollé® made in France. No 1F-EN 166-F) were used to withstand the forces applied during impression taking and manipulation through different measurements. A pair of Velcro® hook and loop straps, (16 mm in width and 25 cm in length) were attached to the ear pieces of the safety glasses bilaterally using soft wire and sticky wax to facilitate the stability on the subject head with the least possible movements.

Using a 0.5 mm round bur, a hole was drilled on the glasses in the area representing the Nasion (in the middle of the glasses' frame) that will be used for the measurements, The distance between the hole made on the glasses and the middle of the incisal edge of the left central incisor was recorded. Two measurements were taken each visit in sitting position and were named TEST 1. This procedure was repeated over five visits where a total of 10 records were collected for each subject. The same measurements were taken in the second set while the subjects in supine position, to evaluate the effect of the posture of the subjects and the gravity on the results; this set of measurements was named TEST 2.

All the records were analyzed using a Microsoft excel spread sheet. Four statistics were calculated:

1. The mean of TEST 1/TEST 2
2. The differences between TEST 1 and TEST 2
3. The standard deviation of the differences
4. The coefficient of repeatability which equals 2*STDEV of the differences.

### B. Validating the 3-D Repositioning System.

The target was to validate the accuracy of the 3D maxillary repositioning system in relocating the position of the maxilla in the space in X, Y, Z planes.

Some modifications were made to the safety glasses to accommodate the web camera on them. Using a rapid cure acrylic resin, a stainless steel screw (15 mm length, 6.2 diameter) was placed on the middle of the glasses (Nasion point), on which the camera was fixed by means of ball and socket joint, which has the ability to modify the position of the camera in relation to the light source and then to be tightened in a unique position for each subject being tested.

Using dental alginate impression material, maxillary impressions were taken for 10 volunteer subjects and occlusal wafers were constructed for each of them.

The occlusal wafers were made from a quick high impact acrylic resin with ball ended clasps attached to each side of them on the upper first premolar and first molar to enhance a maximum retention of the wafers to the maxilla throughout the measurements' procedures.

A square stainless steel tube (30 mm in length) was fixed to the wafer anteriorly, parallel to the occlusal plane and perpendicular to the mid-central incisors point. This tube was used to accommodate the 15 mm probe of the light source (target).

Ten volunteer subjects were recruited for the validation of the 3-D repositioning system. After connecting the camera to the computer, the safety glasses were placed on the subject's head and secured in place with the Velcro straps. The wafer was then placed on the subject's maxillary teeth, on which it was retained by the ball ended clasps. The program was then left running for 10 seconds for each measurement.

Two sets of measurements were recorded:
Set A. The measurements were taken while the subject is in a sitting position on the dental chair.
Set B. The measurements were taken while the subject is in a supine position on the dental chair.

The software is able to provide the operator with the following Data:

1. The angle of the maxillary movements on the sagittal, coronal and axial planes.
2. The distance of the maxilla from the camera in the 3 planes; X, Y, Z.
3. The position of the left molar, right molar, and central incisors in relation to the camera in 3 planes; X,Y,Z

The readings of the distances and angles are the mean of multiple captures in a given time, the software can be set to give the mean reading of 10, 30, 50, and 100 captures, the more the number of captures the more the time required for the software to give the final results and the precision and accuracy of these results. In the results, all the distances are given in mm, and the angles in degrees. The software also gives the variance of the 3 angles and 3 distances in separate columns.

### Validation of the Accuracy of Maxillary Movements on Skull Model Surgery Using the 3D Repositioning System.

To test the accuracy of the 3D repositioning system in controlling the movements of the maxilla during orthognathic surgery, a skull was used to perform the Le Fort I osteotomy. The differences between the movements measured by the 3D system and the digital caliper and displacement gauge were recorded.

Using Colténe® impression material, an impression was taken for the maxilla to construct a surgical wafer. A second impression was taken for the bony nasal bridge and the forehead using the safety glasses. Using the 3D repositioning system, we recorded the pre operative position (reference position). After recording these initial readings, the system was then removed from the skull.

An electrical saw was used to osteotomize the maxilla at Le Fort I level, then four (10 mm) screws were placed on each side of the maxilla below and above the osteotomy line to facilitate the retention of the osteotomized maxilla (using fine elastics) between the readings of each movement of the maxilla. The camera was then placed on its position on the skull and the surgical wafer fixed on the maxilla.

The maxilla was then moved in one direction and the new position was retained using sticky wax and fine elastics on the screws. Using the digital caliper, the amount of movement was measured accurately and recorded. The 3D repositioning system was then used to measure the amount of movement in relation to the pre operative readings (reference position). Five measurements were recorded for each axis (X, Y, Z) from 3 points on the osteotomized maxilla (right first molar, left first molar and midcentral incisors point) following each movement.

In order to validate the 3 D repositioning system, the reading of this system was compared to that of the digital caliper. The differences, mean and CR were calculated.

### Results

Testing the reproducibility of the safety glasses in relocating the maxillary position was carried out using the Coefficient of repeatability (CR). The (CR) formula used in this test equals 2× standard deviation of the differences between repeated measurements (STDEV). The minimum value was 0.052372 corresponding to subject number four and the maximum one was 0.418362 corresponding to subject number one.

The test was also carried out in two positions (Sitting and Supine) to evaluate the differences in the readings when changing the subject's position. Table 1 shows the mean value of the measurements in supine and sitting position for the ten subjects together with differences between the two mean values. The minimum value was −0.022 corresponding to subject number four and the maximum value of the difference was 0.024 corresponding to subject number five.

TABLE 1

| Subject | sitting | supine | Diff | STDEV |
|---|---|---|---|---|
| 1 | 87.88 | 87.861 | −0.019 | 0.013435 |
| 2 | 77.704 | 77.723 | 0.019 | 0.013435 |
| 3 | 92.597 | 92.599 | 0.002 | 0.001414 |
| 4 | 83.662 | 83.64 | −0.022 | 0.015556 |
| 5 | 86.912 | 86.936 | 0.024 | 0.016971 |
| 6 | 78.185 | 78.205 | 0.02 | 0.014142 |
| 7 | 85.46075 | 85.45575 | −0.005 | 0.003536 |
| 8 | 85.751 | 85.7518 | 0.0008 | 0.000566 |
| 9 | 83.812 | 83.8206 | 0.0086 | 0.006081 |
| 10 | 85.36335 | 85.36715 | 0.0038 | 0.002687 |

### Validation of the 3D Maxillary Repositioning System.

Because of the large amount of the data output collected from each subject due to the repeatability, only the minimum and maximum values of differences from the reference position were considered for each axis (X, Y and Z). (Table 2)

TABLE 2
Range of differences in (mm) from the reference position

| X axis | | | | | | | | |
|---|---|---|---|---|---|---|---|---|
| Sub- | | | Y axis | | | Z axis | | |
| ject | min | Max | Subject | min | max | Subject | min | max |
| 1 | −0.41 | 0.554 | 1 | −0.07 | 0.285 | 1 | 0.055 | 0.767 |
| 2 | 0.03 | 0.648 | 2 | −0.59 | 0.311 | 2 | −0.08 | 0.543 |
| 3 | −0.46 | 0.135 | 3 | −0.46 | 0.452 | 3 | −0.26 | 0.42 |
| 4 | −0.62 | 0.576 | 4 | 0.01 | 0.43 | 4 | −0.5 | 0.6 |
| 5 | 0.024 | 0.97 | 5 | −0.06 | 0.645 | 5 | −0.04 | 0.077 |
| 6 | 0.00 | 0.174 | 6 | −0.45 | 0.418 | 6 | 0.034 | 0.202 |
| 7 | −0.10 | 0.516 | 7 | −0.46 | 0.452 | 7 | −0.73 | 0.626 |
| 8 | −0.34 | 0.54 | 8 | −0.46 | 0.261 | 8 | −0.33 | 0.223 |
| 9 | 0.013 | 0.543 | 9 | −0.07 | 0.285 | 9 | −0.28 | 0.52 |
| 10 | −0.08 | 0.543 | 10 | −0.59 | 0.311 | 10 | 0.014 | 0.123 |
| | Min | Max | | Min | Max | | Min | Max |
| | −0.62 | 0.97 | | −0.59 | 0.645 | | −0.73 | 0.767 |

Min: Minimum Value of difference in mm
Max: Maximum Value of difference in mm

Analysis of the results revealed the following statistics:

1. X axis
A. the mean of the minimum differences was −0.18983
B. the mean of the maximum differences was 0.5199
C. the standard error of the mean was 0.247204

### 2. Y-axis

A. the mean of the minimum differences was −0.3238
B. the mean of the maximum differences was 0.385
C. the standard error of the mean was 0.247195
   3. Z axis
A. the mean of the minimum differences was −0.2153
B. the mean of the maximum differences was 0.4101
C. the standard error of the mean was 0.254298

### Application of the 3D Repositioning System on Skull Model Surgery.

Three points on the maxilla were considered for this test, that were the maxillary left and right first molar tooth and the midcentral incisors point which represent the whole body of the maxilla.

The following statistics were calculated:

A. Upper right first molar;
1. Mean of the differences X plane −0.034
2. STDEV of the differences X plane 0.057271
3. Coefficient of repeatability X plane 0.114543
4. Mean of the differences Y plane 0.036
5. STDEV of the differences Y plane 0.05029
6. Coefficient of repeatability Y plane 0.100598
7. Mean of the differences Z plane −0.01
8. STDEV of the differences Z 0.083066
9. Coefficient of repeatability Z plane 0.166132
   B. Central incisors;
1. Mean of the differences X plane 0.004
2. STDEV of the differences X plane 0.0498
3. Coefficient of repeatability X plane 0.099599
4. Mean of the differences Y plane 0.004
5. STDEV of the differences Y plane 0.074699
6. Coefficient of repeatability Y plane 0.149399
7. Mean of the differences Z plane −0.006
8. STDEV of the differences Z plane 0.135757
9. Coefficient of repeatability Z plane 0.271514
   C. Upper left first molar;
1. Mean of the differences X plane 0.002
2. STDEV of the differences X plane 0.031145
3. Coefficient of repeatability X plane 0.06229
4. Mean of the differences Y plane 0.018
5. STDEV of the differences Y plane 0.064576
6. Coefficient of repeatability Y plane 0.129151
7. Mean of the differences Z plane −0.014
8. STDEV of the differences Z plane 0.073007
9. Coefficient of repeatability Z plane 0.14601

### DISCUSSION

The validation of the safety glasses revealed that the highest STDEV was 0.016971 which is considered very low and of no clinical significance, the highest CR was also very low 0.418362.

The 3D maxillary repositioning system that has been developed is highly accurate, it has been calibrated in the Medical Physics Laboratory/UCLH, so that the errors related to the software, camera and target are considerably smaller than those arising from the mounting systems. The minimal errors that appeared in the study can be attributed to the mounting and stability of the safety glasses on the subject's head throughout the measurements procedure, the patient skin type (i.e. elasticity, redundancy), inappropriate manipulation of the safety glasses after taking the reference maxillary position preoperatively and looseness of the surgical wafer.

The results of the safety glasses validation did not show significant differences between the readings in supine and sitting position (the mean of differences between the 2 positions ranges between −0.022 mm and 0.024 mm. The overall estimation of the accuracy of the safety glasses to relocate the maxillary position is within the acceptable range of CR (0.052372-0.418362).

The experimental subject validation of the 3D maxillary reposition system also did not show significant errors. Some variation between the 3 planes (X, Y and Z) readings were noticed, the greatest standard error of the mean of differences from the reference position was noticed in the Z axis which represent the up and down movement of the maxilla (0.254298), it was related to subject number 7 who was noticeably irritable but it is still very small error of no clinical significance.

The application of the system in surgery (skull model) gave the most encouraging results. The maximum CR did not exceed 0.271 corresponding to Z axis of the central incisors and the minimal CR was 0.062 corresponding to X axis of upper left first molar tooth.

As will be appreciated by the skilled person, many modifications and variation of the embodiments described above are possible within the scope of the invention. For instance, although the embodiment has been described in the context of measurements during maxillary osteotomies, a similar approach to tracking movement can be adopted during mandibular osteotomies and other surgical procedures employed to manipulate the facial skeleton.

1. A system for measuring relative movement between two portions of the facial skeleton, the system comprising:
a target fixed in position relative to a one of said portions of the facial skeleton, the target comprising three or more light sources having a known geometric relationship with one another; and
an image capture device fixed in position relative to the other of said portions of the facial skeleton for capturing images of the three or more light sources of the target.

2. A system according to claim 1, wherein the target includes four or more distinct light sources.

3. A system according to claim 2, wherein the light sources are arranged in a three-dimensional configuration so that they are not all in the same plane.

4. A system according to claim 3, wherein the target comprises four light sources arranged in a tetrahedral configuration.

5. A system according to claim 1, wherein the light sources are of a uniform shape and intensity.

6. A system according to claim 1, wherein the light sources are mounted in a body, a surface of the body on which the sources are visible having a colour that contrasts with the colour of the light sources to help the clarity of the image of the spot pattern.

7. A system according to claim 1, wherein the image capture device is a digital camera.

8. A system according to claim 7, wherein the camera comprises a charge coupled device (CCD) as the image capture element.

9. A system according to claim 1, wherein the target is adapted to be fixed in position relative to the maxilla or mandible and the image capture device is adapted to be fixed in position relative to the remainder of the facial skeleton.

10. A system according to claim 9, wherein the target is adapted for mounting on the upper or lower teeth of a patient.

11. A system according to claim 10, having a support structure for the target that comprises a fixture adapted to be secured to the patient's teeth and a target mounting portion that, in use, protrudes forwardly from the patient's mouth and on which the target is mounted or formed integrally with.

12. A system according to claim 11, wherein the fixture is an occlusal wafer.

13. A system according to claim 1, wherein the image capture device is mounted adjacent the frontal bone or nasal bone of the patient's facial skeleton.

14. A system according to claim 13, having a camera mount that comprises a face-engaging portion that is located on the patient's forehead and/or the bridge of their nose.

15. A system according to claim 14, wherein the face-engaging portion of the mount is formed to closely match the contours of the patient's face that it overlies.

16. A system according to claim 1, further comprising processing means that calculate a change in position of the facial skeleton portions with respect to one another based on a series of two or more images of the target captured by the image capture means.

17. A system according to claim 16, wherein the processing means determines that position and orientation of the target relative to the image capture device, as seen in any particular captured image, by comparing the pattern of spots in the image with a virtual model of the target that models the geometry of the light sources.

18. A method of measuring relative movement between two portions of a facial skeleton, the method comprising:
mounting a target in a fixed position relative to one of said facial skeleton portions, the target comprising two or more light sources having a known geometric relationship with one another;
mounting an image capture device in a fixed position relative to the other of said facial skeleton portions, the image capture device being oriented such that the light sources of the target re within its field of vision;
capturing with the image capture device a series of two or more images of the pattern of spots formed by the light sources on the target; and
calculating a relative movement of one portion of the facial skeleton with respect to the other based on a change in the pattern of spots between one captured image and one or more subsequently captured images in the series of captured images.

19. A method according to claim 18, wherein when the image capture device is first mounted on the patient it is positioned so that the light sources are within the field of view of the image capture device and will stay within the field of view throughout the anticipated movement of the target with respect to the image capture device.

20. A computer readable medium having stored thereon instructions, which when executed by a processor, cause the processor to perform: a relative movement of one portion of the facial skeleton with respect to the other based on a change in the pattern of spots between one captured image and one or more subsequently captured images in the series of captured images.

21. A system for measuring relative movement between two objects, the system comprising:
a target fixed in position relative to a one of said objects, the target comprising three or more light sources having a known geometric relationship with one another; and
an image capture device fixed in position relative to the other of said objects for capturing images of the three or more light sources of the target.

22. A method of measuring relative movement between two objects, the method comprising:
mounting a target in a fixed position relative to one of said objects, the target comprising three or more light sources having a known geometric relationship with one another;
mounting an image capture device in a fixed position relative to the other of said objects, the image capture device being oriented such that the light sources of the target are within its field of vision;
capturing with the image capture device a series of two or more images of the pattern of spots formed by the light sources on the target; and
calculating a relative movement of one of the objects with respect to the other based on a change in the pattern of spots between one captured image and one or more subsequently captured images in the series of captured images.
